(19) United States
(12) Patent Application Publication
(10) Pub. No.: US 2016/0208728 A1
(43) Pub. Date: Jul. 21, 2016

(54) FUEL SUPPLY CONTROLLER

(71) Applicant: TOYOTA JIDOSHA KABUSHIKI KAISHA, Toyota-shi, Aichi-ken (JP)

(72) Inventor: Keita SHIGEMORI, Toyota-shi, Aichi-ken (JP)

(73) Assignee: TOYOTA JIDOSHA KABUSHIKI KAISHA, Toyota-shi, Aichi-ken (JP)

(21) Appl. No.: 14/915,073

(22) PCT Filed: Aug. 12, 2014
(86) PCT No.: PCT/IB2014/001508

§ 371 Date: Feb. 26, 2016

(30) Foreign Application Priority Data
Sep. 4, 2013 (JP) 2013-183324

(51) Int. Cl. F02D 41/30; B60K 28/14; B60R 21/01; B60K 15/00

(52) U.S. Cl. CPC F02D 41/3005; B60K 15/00; B60K 28/14; B60R 21/01

(57) ABSTRACT

A fuel supply controller includes a receiver unit that receives a collision signal, which indicates that a vehicle has a collision, transmitted from an external device, an engine stop detecting unit that detects a stop of an engine mounted on the vehicle, and a fuel supply stopping unit that stops a supply of a fuel to the engine when the collision signal is received by the receiver unit and the stop of the engine is detected by the engine stop detecting unit.

### BACKGROUND OF THE INVENTION

1. Field of the Invention

The present invention relates to a fuel supply controller, and more particularly, to a fuel supply controller that can appropriately stop a supply of a fuel to an engine when a vehicle has a collision.

2. Description of Related Art

A fuel supply controller is known which is mounted on a vehicle and which stops a supply of a fuel to an engine by stopping a fuel pump when a collision signal transmitted at the time of a vehicle collision is received (for example, see Japanese Patent Application Publication No. 2013-071577 (JP 2013-071577 A). The fuel supply controller includes an engine-control electronic control unit (for example, EFI-ECU) that controls the supply of a fuel to the engine. The engine-control electronic control unit is connected to an airbag-control electronic control unit (for example, airbag ECU) that controls inflation of an airbag. The airbag-control electronic control unit is connected to a collision sensor such as an acceleration sensor that detects a collision of the vehicle.

The airbag-control electronic control unit detects a collision of the vehicle on the basis of a signal supplied from the collision sensor. When a collision of the vehicle is detected, the airbag-control electronic control unit transmits a collision signal indicating that the vehicle has a collision to the engine-control electronic control unit. When receiving the collision signal transmitted from the airbag-control electronic control unit, the engine-control electronic control unit stops the supply of a fuel to the engine by stopping a fuel pump. Accordingly, it is possible to prevent the fuel from leaking from the fuel pump at the time of the vehicle collision.

However, in the controller described in JP 2013-071577 A, when the engine-control electronic control unit receives the collision signal transmitted from the airbag-control electronic control unit, the supply of a fuel to the engine is always stopped. Accordingly, even when the collision signal received by the engine-control electronic control unit is not duly transmitted from the airbag-control electronic control unit, the supply of a fuel to the engine is stopped and thus there is a possibility that the supply of a fuel to the engine will be excessively limited.

### SUMMARY OF THE INVENTION

The present invention provides a fuel supply controller that can certainly stop a supply of a fuel to an engine at the time of vehicle collision and prevent the supply of a fuel to the engine from being erroneously stopped in response to an erroneous collision signal.

According to an aspect of the present invention, there is provided a fuel supply controller including: a receiver unit that receives a collision signal, which indicates that a vehicle has a collision, transmitted from an external device; an engine stop detecting unit that detects a stop of an engine mounted on the vehicle; and a fuel supply stopping unit that stops a supply of a fuel to the engine when the collision signal is received by the receiver unit and the stop of the engine is detected by the engine stop detecting unit.

In the fuel supply controller according to the aspect of the present invention, it is possible to certainly stop a supply of a fuel to an engine at the time of vehicle collision and to prevent the supply of a fuel to the engine from being erroneously stopped in response to an erroneous collision signal.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating a configuration of a fuel supply controller according to an embodiment of the present invention; and

FIG. 2 is a flowchart illustrating an example of a control routine that is performed by the fuel supply controller according to the embodiment.

### DETAILED DESCRIPTION OF EMBODIMENTS

Hereinafter, a fuel supply controller according to a specific embodiment of the present invention will be described with reference to the accompanying drawings.

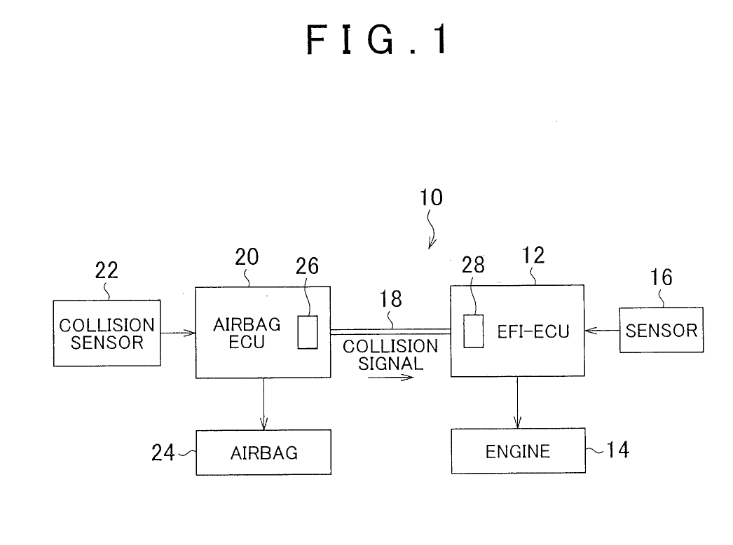

FIG. 1 is a diagram illustrating a configuration of a fuel supply controller 10 according to an embodiment of the present invention. The fuel supply controller 10 according to this embodiment is a device for controlling a supply of a fuel to an engine mounted on a vehicle.

As illustrated in FIG. 1, the fuel supply controller 10 includes an engine-control electronic control unit (hereinafter, referred to as EFI-ECU) 12 including a microcomputer as a main body. The EFI-ECU 12 is connected to an engine 14 that generates power of a vehicle. The engine 14 is equipped with a fuel pump, a fuel injector, an intake unit, an ignition unit, and the like. The engine 14 generates the power by mixing and exploding a fuel and air while injecting the fuel supplied from a fuel tank using the fuel pump from an injection nozzle.

The EFI-ECU 12 is connected to a sensor 16 needed to control the supply of a fuel to the engine 14. Examples of the sensor 16 includes a cam position sensor that outputs a signal (a cam angle signal) corresponding to an angular position of a cam shaft attached to the engine 14 and a rotation angle sensor that outputs a signal (a rotation angle signal) corresponding to the rotation signal of the engine 14. The output signals of the sensors 16 are supplied to the EFI-ECU 12. The EFI-ECU 12 controls the supply of a fuel to the engine 14 by controlling the timing of supplying the fuel to the engine 14 or the amount of fuel on the basis of the output signals of the sensors 16.

The EFI-ECU 12 is connected to an airbag-control electronic control unit (hereinafter, referred to as an airbag ECU) 20 via a communication line 18. The communication line 18 is an in-vehicle LAN that connects various ECUs or sensors including at least the EFI-ECU 12 and the airbag ECU 20 mounted on the vehicle to each other and an example thereof is a control area network (CAN) communication line. The communication line 18 realizes communications based on a predetermined communication protocol. Various ECUs or sensors connected to each other via the communication line 18 are provided with a transmitter and receiver unit for communications based on the communication protocol.

The airbag ECU 20 is connected to a collision sensor 22. The collision sensor 22 is, for example, an acceleration sensor for detecting a collision of the vehicle. An output signal of the collision sensor 22 is supplied to the airbag ECU 20. The airbag ECU 20 includes a microcomputer as a main body and has a function of determining whether the vehicle has a collision with an object such as another vehicle, a guard rail, and a wall on the basis of the output signal of the collision sensor 22.

The airbag ECU 20 is connected to an airbag 24. The airbag 24 is equipped with an inflator that generates high-pressure gas. The airbag ECU 20 is an electronic control unit that controls inflation of the airbag 24 and has a function of supplying a gas generation instructing signal to the inflator when it is determined that the vehicle has a collision on the basis of the signal from the collision sensor 22. The airbag 24 is inflated and developed with the high-pressure gas generated in response to the gas generation instruction from the airbag ECU 20.

When it is determined that the vehicle has a collision on the basis of the signal from the collision sensor 22, the airbag ECU 20 generates a collision signal indicating that the vehicle has a collision and transmits the collision signal from the transceiver unit 26 to the communication line 18. The collision signal transmitted from the transceiver unit 26 of the airbag ECU 20 to the communication line 18, passes through the communication line 18, and is then received by a transceiver unit 28 of the EFI-ECU 12.

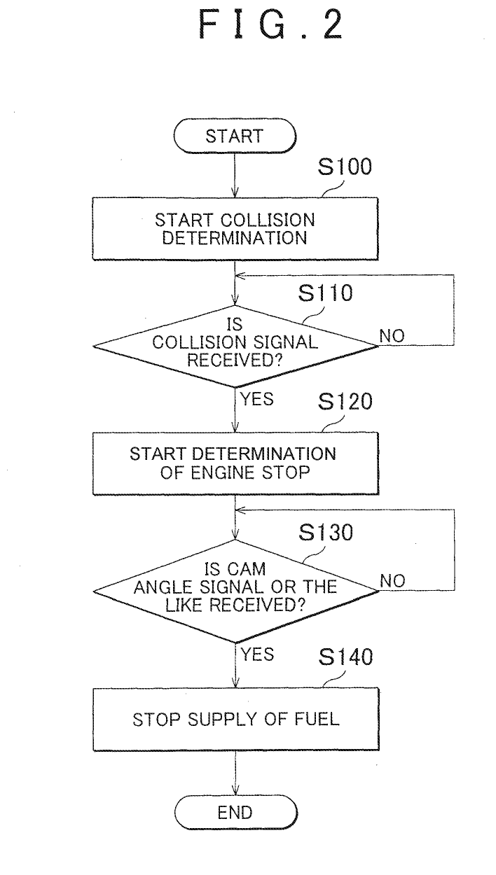

A distinctive operation of the fuel supply controller 10 according to this embodiment will be described below with reference to FIG. 2. FIG. 2 is a flowchart illustrating an example of a control routine that is performed by the EFI-ECU 12 in the fuel supply controller 10 according to this embodiment.

In this embodiment, the EFI-ECU 12 starts a supply of .a fuel to the engine 14 after an ignition switch is turned on. When the supply of a fuel to the engine 14 is started, the engine 14 generates power for causing the vehicle to run. After the supply of a fuel to the engine 14 is started, the EFI-ECU 12 starts determination of whether the vehicle has a collision (collision determination) (step 100). The EFI-ECU 12 performs the collision determination of the vehicle on the basis of whether a collision signal transmitted from the airbag ECU 20 via the communication line 18 is received by the transceiver unit 28 (step 110).

As a result, when it is determined that a collision signal is not received from the airbag ECU 20 via the communication line 18, the process of collision determination is repeatedly performed. On the other hand, when it is determined that a collision signal is received from the airbag ECU 20 via the communication line 18, determination of whether the engine 14 is actually stopped (engine stop determination) is started (step 120).

The EFI-ECU 12 performs the engine stop determination on the basis of the output signal of the sensor 16 connected thereto (step 130). Specifically, the engine stop determination can be performed on the basis of whether or not a cam angle signal from a cam position sensor as the sensor 16 or a rotation angle signal from a rotation angle sensor is input to the EFI-ECU 12. In this case, when the cam angle signal or the rotation angle signal varies with the lapse of time, it is determined that the engine 14 is not stopped. On the other hand, when the cam angle signal or the rotation angle signal does not vary with the lapse of time, it is determined that the engine 14 is stopped.

When it is determined in step 130 that the engine 14 is not stopped, the EFI-ECU 12 repeatedly performs the engine stop determination. On the other hand, when it is determined that the engine 14 is stopped, the EFI-ECU 12 stops the supply of a fuel to the engine 14 (step 140). When the supply of a fuel to the engine 14 is stopped, the supply of a fuel from the fuel tank is not performed and thus a new supply of a fuel to the engine 14 is not performed.

In this way, in this embodiment, when the collision signal, which indicates that the vehicle has a collision, output from the airbag ECU 20 is input to the EFI-ECU 12 via the communication line 18, the supply of a fuel to the engine 14 is stopped and the operation of the engine 14 is stopped. Accordingly, according to this embodiment, since the operation of the engine 14 can be prevented from being unnecessarily performed for a long time at the time of the vehicle collision, it is possible to improve safety at the time of the vehicle collision.

In this embodiment, the supply of a fuel to the engine 14 is not always stopped when the collision signal from the airbag ECU 20 is input to the EFI-ECU 12 via the communication line 18. That is, when the collision signal from the airbag ECU 20 is input to the EFI-ECU 12 but the cam angle signal or the rotation angle signal varying with the lapse of time is not received after the collision signal is input, it is determined that the engine 14 is actually stopped due to the vehicle collision and the supply of a fuel to the engine 14 is stopped. However, when the cam angle signal or the rotation angle signal varying with the lapse of time is received after the collision signal is input, it is determined that the engine 14 actually operates and thus the vehicle collision does not actually occur, and the supply of a fuel to the engine 14 is continuously performed.

In general, when a vehicle actually collides, a fuel supply passage or an intake passage may be cut off or devices may be destroyed. Accordingly, the engine 14 has a difficulty in continuous operation and there is a possibility that the operation of the engine 14 will be stopped. On the other hand, when a vehicle does not collide, the cut-off or destruction does not occur. Accordingly, the engine 14 can be easily operated and there is no possibility that the operation of the engine 14 will be stopped. When the collision signal is erroneously input to the EFI-ECU 12 such as when the collision signal input to the EFI-ECU 12 is not duly output from the airbag ECU 20, the supply of a fuel to the engine 14 is excessively limited by immediately stopping the supply of a fuel to the engine 14, and thus there is a problem in that the engine 14 may be suddenly stopped.

On the contrary, in this embodiment, when the collision signal from the airbag ECU 20 is input to the EFI-ECU 12 via the communication line 18, the supply of a fuel to the engine 14 is not immediately stopped. When the collision signal from the airbag ECU 20 is input to the EFI-ECU 12 via the communication line 18 but the cam angle signal or the rotation angle signal varying with the lapse of time is received, it is determined that the engine 14 is actually operated, the vehicle collision does not actually occur, and there is a high possibility that t the collision signal is not duly output from the airbag ECU 20, and thus the supply of a fuel to the engine 14 is continuously performed. On the other hand, when the cam angle signal or the rotation angle signal varying with the lapse of time is not received, it is determined that the engine 14 is stopped due to the vehicle collision and there is a high possibility that the collision signal is duly output form the airbag ECU 20, and thus the supply of a fuel to the engine 14 is stopped.

That is, according to the configuration of this embodiment, the process of stopping the supply of a fuel to the engine 14 when the collision signal from the airbag ECU 20 is input to the EFI-ECU 12 via the communication line 180 can be performed depending on whether or not the engine 14 is actually stopped, which is detected on the basis of the signal from the sensor 16 the EFI-ECU 12, specifically, it can be determined that the collision signal is duly output and the process can be performed only when the engine 14 is actually stopped due to the vehicle collision.

Therefore, the fuel supply controller 10 according to this embodiment can certainly stop the supply of a fuel to the engine 14 when the vehicle has a collision and to prevent the supply of a fuel to the engine 14 from being erroneously stopped in response to an erroneous collision signal input to the EFI-ECU 12 via the communication line 18. Accordingly, according to this embodiment, it is possible to improve safety of the vehicle by stopping the engine 14 at the time of the vehicle collision and to prevent the engine 14 from being suddenly stopped in response to an erroneous collision signal.

In this embodiment, when it is determined that the cam angle signal or the rotation angle signal from the sensor 16 varies with the lapse of time after the collision signal is received and thus the engine is not stopped, the EFI-ECU 12 determines that the vehicle does not actually collide, an erroneous collision signal is input, and does not stop the supply of a fuel to the engine 14 based on the collision signal. On the other hand, when it is determined that the cam angle signal or the rotation angle signal from the sensor 16 does not vary with the lapse of time after the collision signal is received and thus the engine is stopped, the EFI-ECU 12 determines that the vehicle actually collides and a duly collision signal is input, and thus stops the supply of a fuel to the engine 14 based on the collision signal.

Accordingly, in the configuration according to this embodiment, in preventing the supply of a fuel to the engine 14 from being erroneously stopped in response to an erroneous collision signal input to the EFI-ECU 12 via the communication line 18, the output signal of the sensor 16 that is normally used in the engine control by the EFI-ECU 12 is used. Therefore, according to this embodiment, in preventing the erroneous stop of the supply of a fuel to the engine 14 based on the erroneous collision signal, it is not necessary to add a particular dedicated hardware configuration such as a wire for connection to the EFI-ECU 12 and it is not also necessary to excessively complicate the conditions for determining whether the collision signal input to the EFI-ECU 12 is erroneous. Accordingly, it is possible to realize prevention of erroneous stop of the supply of a fuel to the engine 14 based on the erroneous collision signal.

In the above-mentioned embodiment, the airbag ECU 20 is an example of the “external device” described in the claims, the transceiver unit 28 of the EFI-ECU 12 is an example of the “receiver unit” described in the claims, the performing of the process of step 130 in the routine illustrated in FIG. 2 by the EFI-ECU 12 is an example of the “engine stop detecting unit”, the performing of the process of step 140 by the EFI-ECU 12 is an example of the “fuel supply stopping unit” described in the claims, and the communication line 18 is an example of the “CAN communication line” described in the claims.

In the above-mentioned embodiment, the communication line 18 connecting the EFI-ECU 12 and the airbag ECU 20 to each other is, for example, the CAN communication line, but the present invention is not limited to this example and may employ any unit other than the CAN communication line.

In the above-mentioned embodiment, an ECU that transmits the collision signal indicating that the vehicle has a collision is the airbag ECU 20 that controls the inflation of the airbag 24, but the present invention is not limited to this configuration and may employ any unit that can transmit at least the collision signal.

In the above-mentioned embodiment, the value from the sensor 16 such as the cam position sensor or the rotation angle sensor normally used for the EFI-ECU 12 to control the engine is used for the EFI-ECU 12 to determine whether or not the engine 14 is stopped after the collision signal is input. However, the present invention is not limited to this configuration, and a value of a sensor other than the cam position sensor or the rotation angle sensor may be used or a value of a sensor normally used to control the engine may be used.

1. A fuel supply controller comprising:
a receiver unit that receives a collision signal, which indicates that a vehicle has a collision, transmitted from an external device;
an engine stop detecting unit that detects a stop of an engine mounted on the vehicle; and
a fuel supply stopping unit that stops a supply of a fuel to the engine when the collision signal is received by the receiver unit and the stop of the engine is detected by the engine stop detecting unit.

2. The fuel supply controller according to claim 1, wherein the fuel supply stopping unit stops the supply of a fuel to the engine when the stop of the engine is detected by the engine stop detecting unit after the collision signal is received by the receiver unit.

3. The fuel supply controller according to claim 1, wherein the external device and the receiver unit are connected to each other via a CAN communication line.

4. The fuel supply controller according to claim 1, wherein the engine stop detecting unit detects the stop of the engine on the basis of an output signal of a cam position sensor that outputs a signal corresponding to an angle of a cam shaft.

5. The fuel supply controller according to claim 1, wherein the engine stop detecting unit detects the stop of the engine on the basis of an output signal of a rotation angle sensor that outputs a signal corresponding to a rotation angle of the engine.

6. The fuel supply controller according to claim 1, wherein the external device is an airbag device that controls inflation of an airbag.
